(19) United States
(12) Patent Application Publication
(10) Pub. No.: US 2012/0200130 A1
(43) Pub. Date: Aug. 9, 2012

(54) Jersey Covers

(76) Inventors: Kevin Brinker, Easton, PA (US); Keith Brinker, Easton, PA (US)

(21) Appl. No.: 13/365,875

(22) Filed: Feb. 3, 2012

Related U.S. Application Data
(60) Provisional application No. 61/439,630, filed on Feb. 4, 2011.

(51) Int. Cl. A47C 31/00; A47D 15/00; B60N 2/60

(52) U.S. Cl. 297/220

(57) ABSTRACT

An architecture is presented that provides a removable seat cover for an automobile seat that may display a sports-theme, and more particularly to a customizable automobile seat back and head rest cover displaying the likeness of an authentic sports jersey or uniform adjustable to a users design preferences.

### CROSS-REFERENCE

This application claims priority from Provisional Patent Application Ser. No. 61/439,630 filed Feb. 4, 2011.

### FIELD OF THE INVENTION

This invention pertains generally to a removable seat cover for an automobile seat made in the likeness of a sports uniform, and more particularly to a sports-themed seat cover for displaying the likeness of a professional sports jersey on the backrest and headrest portions of an automobile seat.

### BACKGROUND

Sports fans are frequently looking for new opportunities to show support for their favorite team or player. While there are a multitude of options for sports team apparel, there are few options for decorating an automobile. Popular vehicle adornments include personalized license plates or license plate frames, stickers, decals, and the like. Existing sports-themed seat covers tend to be generic looking and are not able to be customized.

Therefore, a customizable and adjustable vehicle seat cover made in the likeness of a professional sports jersey would be desirable. The proposed invention allows a user to customize a seat cover for an automobile that is made from the same materials as authentic sports jerseys. The seat cover may be slid over the seat of a vehicle allowing a sports fan a unique way of showing team pride. A seat cover may be customizable to include a representation of a favorite sports team jersey or uniform, and personalized to include their own name, or the name of a favorite athlete. In addition to displaying support for a sports team, the seat cover may also protect the vehicle seat from wear or stains.

### SUMMARY

Accordingly, the present invention overcomes the limitations of the prior art by providing a unique and useful customizable automobile seat cover made in the likeness of a sports team uniform.

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a seat cover for enveloping a portion of an automobile seat capable of decorating an automobile to show support or preference for a particular sports team and/or player. In one embodiment, the seat cover comprises a front panel and a rear panel made from or designed to emulate a sports team jersey. Preferably, the seat cover slides over and encases a backrest of an automobile seat so that the seat cover is visible from outside of the automobile. Additionally, the seat cover slides over and encases a separate headrest of the automobile seat so that the seat cover is visible from outside of the automobile.

The seat cover allows a user to display support for a favorite sports team or player. Once positioned over the back rest, the seat cover is securable to maintain a form-fitting appearance. Further, the seat cover may additionally comprise the headrest portion for customizing the head rest of the automobile seat. The seat cover is customizable in that a user may include personalized design elements such as the user's name or a favorite player's name in addition to having the appearance of a sports team jersey.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a seat cover in accordance with the disclosed architecture.

FIG. 2 illustrates a side view of the seat cover in accordance with the disclosed architecture.

FIG. 3 illustrates a front view of the seat cover in accordance with the disclosed architecture.

FIG. 4 illustrates a rear view of the seat cover in accordance with the disclosed architecture.

FIG. 5 illustrates a front and rear view of a head rest portion of the seat cover in accordance with the disclosed architecture.

### DETAILED DESCRIPTION

Personalization of a wide variety of devices is a common pastime. More specifically, sports enthusiasts often put a great deal of effort into showing off pride in a favorite team or player. Accordingly, the disclosed device is designed for individuals who desire the ability to adorn their vehicle to show their support as fans. This device allows individuals to customize a vehicle seat with a covering that not only shows team loyalty by displaying authentic sports memorabilia, but that protects the vehicle seat as well.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

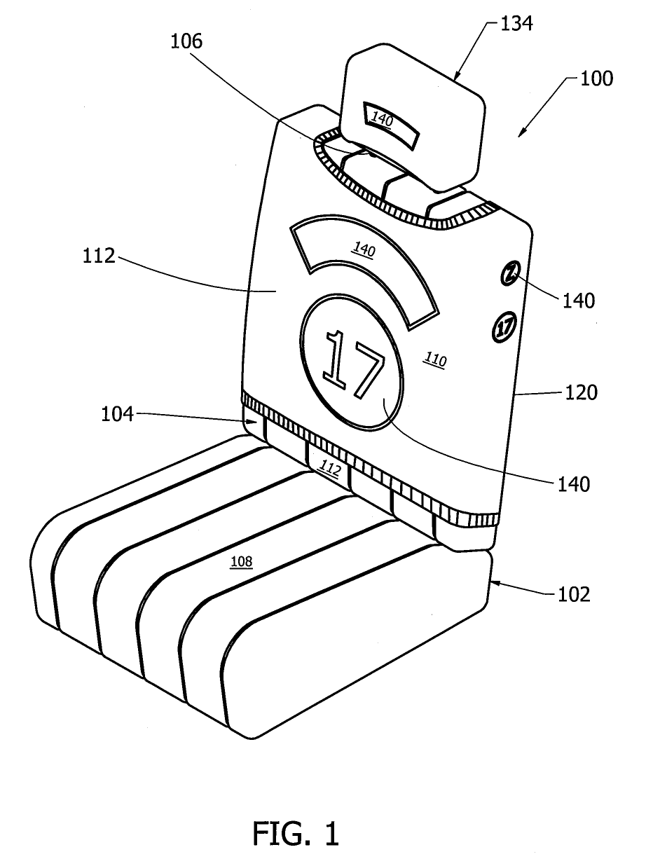

Referring initially to the drawings, FIG. 1 illustrates a seat cover 100 for covering a backrest 104 of a seat 102. The seat 102 is preferably an automobile bucket seat, however the seat cover 100 may also be used with any type of seating fixture such as but not limited to a vehicle seat, a recliner, a chair, a beach chair, a child's car seat, a child's booster seat, an outdoor chair, or the like. The seat 102 typically comprises the backrest 104, a separate headrest 106, and a sitting portion 108.

The seat cover 100 is generally constructed of a pliable material, such as a stretchable fabric for example. Typically, the pliable material is polyester, however this is not intended as a limitation, as any other suitable durable material such as spandex, elastane, cotton, fabric mesh, plastic, and the like may be used without affecting the overall concept of the invention. Preferably, the pliable material comprises or simulates materials commonly used for professional and amateur sports team jerseys and uniforms, such as a team jersey from the NFL, NBA, NHL, NCAA, and the like. This is advantageous as it allows for a high quality form fitting covering that is customizable to support a user's preference in promoting or displaying a favorite sports team and/or player. An additional benefit provided by the seat cover 100 is the physical protective barrier provided to keep the seat 102 unstained and in good condition. Similarly, an additional protective coating (not shown), such as a stain guarding or waterproofing spray may be applied to increase protection.

The seat cover 100 comprises a backrest portion 110, a headrest portion 134, and a plurality of decorative elements 140. The backrest portion 110 comprises a front panel 112 and a rear panel 116. The front and rear panels 110, 112 may be constructed by using a sports team jersey (not shown) or a sports team uniform (not shown) already in existence. The sports team jersey may be split apart so that it is separated into a front and a back, which in turn become the front panel 112 and the rear panel 116. Preferably, the back of the sports team jersey becomes the front panel 112, and the front of the sports team jersey becomes the rear panel 116. However, as the invention is customizable, this is not meant as a limitation as the reverse could be true, more than one sports team jerseys could be used, or any combination of sports team jerseys suiting the user's preference is acceptable. Similarly, the front and rear panels 110, 112 may be constructed by using separate material that is not from, but is similar to that used in official sportswear.

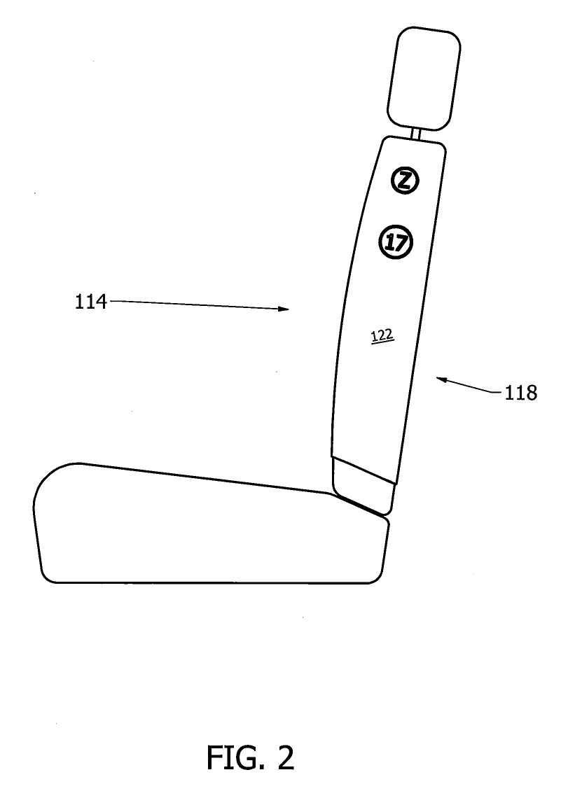

As illustrated in FIG. 2, the seat cover 100 further comprises a first side panel 120 and a second side panel 122. The first and second side panels 120, 122 are typically made from the same or similar material as the front and rear panels 112, 116. The seat cover 100 is constructed by attaching and/or connecting the front and rear panels 112, 116 with the first and second side panels 120, 122 so that seat cover 100 becomes a single assembled uniform piece. In other words, the first and second side panels 120, 122 are sewn or otherwise affixed to the front and rear panels 112, 116 so that there are no arm holes, but where there is a top opening 124 and a bottom opening 130. In an alternative embodiment, a hook and loop or zippered fastening system could be employed to make the seat cover 100 adjustable. Similarly, a version of the seat cover 100 where the first and second side panels 120, 122 were not present to accommodate a small seat is envisioned. Likewise, the seat cover 100 is customizable so as to size to fit a variety of different sized or shaped seats.

Once assembled, the bottom opening 130 of the seat cover 100 simply slides over the backrest 104 of the seat 102 and the top opening 124 slides over the separate headrest 106. Therefore, the backrest 106 is substantially covered or encapsulated by the seat cover 100 until removed. The seat cover 100 is typically oriented so that the front panel 112 is adjacent to a front of the backrest 114, and the rear panel 116 is adjacent to a rear of a backrest 118. For example, a front side (not shown) of the sports jersey would face a rear of a vehicle so that an observer from the front of the vehicle would typically view the rear of the sports jersey.

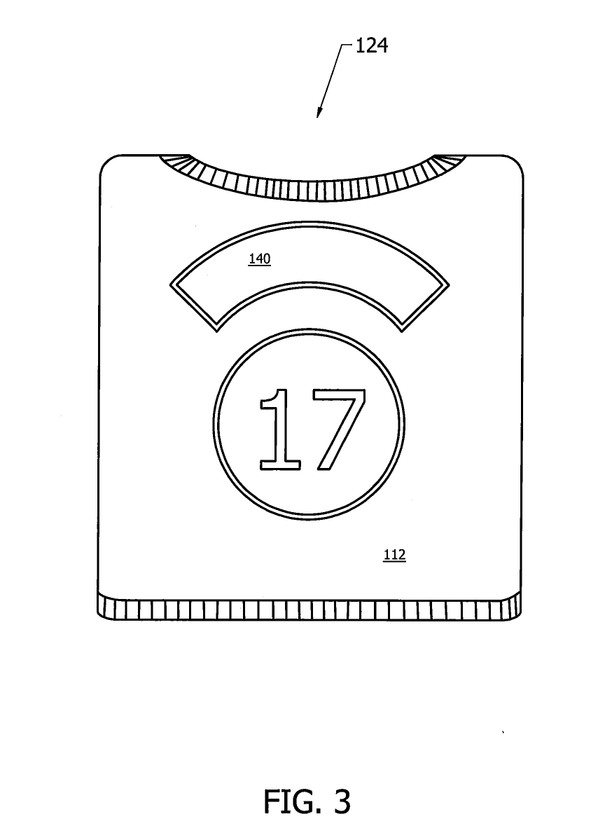

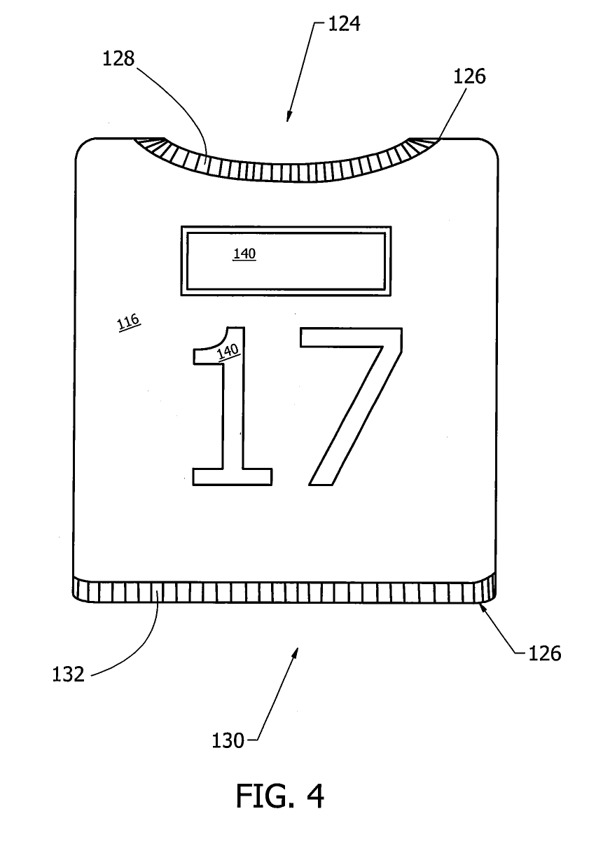

As seen in FIGS. 3 and 4, the top opening 124 is typically a neck hole of the sports team jersey. While the top opening 124 is typically V-shaped, the shape may be oval, circular, square, rectangular, trapezoidal, elliptical, and the like, without deviating from the scope of the invention. Additionally, the seat cover 100 further comprises at least one adjustable element 126. The at least one adjustable element 126 comprises a top stretchable element 128. The top stretchable element 126 substantially encompasses the perimeter of the top opening 124. The at least one adjustable element 126 is generally flexible and comprises elastic material. However, any stretchable material such as rubber, an elastic band, a drawstring, a cinchable strap, a waist band, a hook and loop fastener, and the like may be employed. This flexibility allows the top opening 124 to slide over the separate headrest 106 and helps hold the seat cover 100 in position on the backrest 104.

The at least one adjustable element 126 further comprises a bottom stretchable element 132 which substantially encompasses the perimeter of the bottom opening 130 in a similar manner as the top stretchable element 128, as discussed supra. The bottom stretchable element 132 is similarly adjustable and helps hold the seat cover 100 in position on the backrest 104 without the seat cover 100 bunching up around the backrest 104.

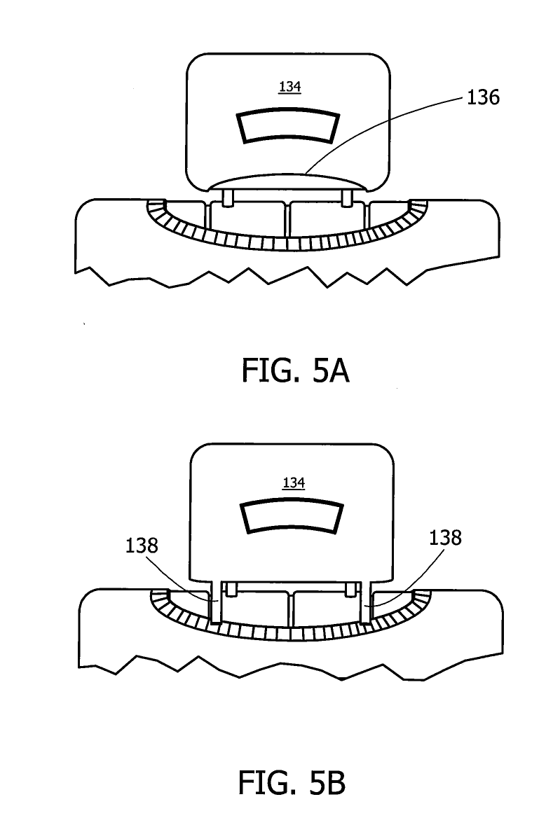

As illustrated in FIG. 5, the headrest portion 134 encapsulates and substantially covers the separate headrest 106. Preferably the headrest portion 134 is separate from the backrest portion 110 of the seat cover 100, but is constructed of similar or identical form-fitting flexible material. However, the inventor contemplates an alternative embodiment where the headrest portion 134 is selectively attached to the backrest portion 110, such as by an attachment element 138 comprising a Velcro® strap for example. Additionally, the headrest portion 132 comprises an elastic element 136 similar in material and function to the at least an adjustable element 126 as discussed supra. Therefore, the headrest portion 134 fits over the separate head rest 106 and is held in place by the elastic element 136 whether facing toward the front or the rear of the vehicle. Also, the user need not utilize the entire embodiment. For example, the backrest portion 110 may be used by itself independent of the headrest portion 134 if desired.

As illustrated in FIGS. 1-5, the plurality of decorative elements 140 typically comprise numbers, decals, sports logos, a sports team name, designs, patches, names, mascots, slogans, nameplates, and the like. Additionally, the plurality of decorative elements 140 may be custom designed to include any decorative type element desirable, the owners name for example. Preferably, the plurality of decorative elements 140 are consistent with the appearance of a sports team jersey. The plurality of decorative elements 140 may be affixed by sewing, ironing on, radio-frequency welding, and the like, or by any method known by one of skill in the art for attaching similar materials. Similarly, the plurality of decorative elements 140 may be oriented anywhere on the backrest portion 110 and the headrest portion 134.

What has been described above includes examples of the disclosed device. It is, of course, not possible to describe every conceivable combination of components and/or methodologies, but one of ordinary skill in the art may recognize that many further combinations and permutations are possible. Accordingly, the novel device is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A seat cover for covering a backrest of a seat, the seat cover comprising:
a front panel;
a rear panel;
a first side panel and a second side panel;
a top opening and a bottom opening; and
a headrest covering element; and
wherein the seat cover resembles a jersey of a sports team.

2. The seat cover of claim 1, wherein the seat cover comprises a pliable material.

3. The seat cover of claim 2, wherein the seat cover comprises at least one of the following materials: polyester, cotton, mesh, plastic, spandex, tackle twill, silk screen, iron-on patch or fabric.

4. The seat cover of claim 1, wherein the top opening and the bottom opening are adjustable.

5. The seat cover of claim 1, wherein the first side panel and the second side panel connect the front panel and the rear panel.

6. The seat cover of claim 1, wherein the seat comprises at least one of the following: an automobile seat, a recliner, a chair, a beach chair, a child's car seat, a child's booster seat, or an outdoor chair.

7. A seat cover for covering a backrest of an automobile seat, the seat cover comprising:
a front panel;
a rear panel;
a first side panel and a second side panel for connecting the front panel and the rear panel;
a top opening and a bottom opening; and
a headrest covering element; and
wherein the seat cover resembles a jersey of a sports team.

8. The seat cover of claim 7, wherein the top opening comprises at least one of the following shapes: an oval, an ellipse, a V-shaped opening, a circle, a rectangle, a square, or a trapezoid.

9. The seat cover of claim 7, wherein the bottom opening further comprises at least one adjustable element.

10. The seat cover of claim 9, wherein the at least one adjustable element comprises one of the following: an elastic band, a drawstring, a cinchable strap, a waist band, or a hook and loop fastener.

11. The seat cover of claim 7, wherein the jersey comprises a sports team jersey or a sports uniform.

12. The seat cover of claim 11, wherein a front side of the sports jersey faces a rear of a vehicle.

13. The seat cover of claim 6, wherein the top opening is a neck opening of the sports jersey.

14. A seat cover for covering a backrest and a headrest of an automobile seat, the seat cover comprising:
a backrest portion comprising:
a front panel;
a rear panel;
a first side panel and a second side panel for connecting the front panel and the rear panel;
a top opening and a bottom opening; and
a headrest portion separate from the back rest portion; and
wherein the seat cover resembles a jersey of a sports team.

15. The seat cover of claim 14, wherein the seat cover further comprises a plurality of decorative elements.

16. The seat cover of claim 15, wherein the plurality of decorative elements comprises one of the following: a sports logo, a sports team name, a number, a design, a picture, an emblem, a name, a mascot, or a slogan.

17. The seat cover of claim 14, wherein the headrest portion comprises an adjustable element.

18. The seat cover of claim 14, wherein the headrest portion comprises an attachment element for connecting the head rest portion to the back rest portion.

19. The seat cover of claim 14, wherein the headrest portion is a formfitting adjustable cover.

20. The seat cover of claim 14, wherein the headrest portion is reversible.
